(19) United States
(12) Patent Application Publication
(10) Pub. No.: US 2008/0301579 A1
(43) Pub. Date: Dec. 4, 2008

(54) Interactive interface for navigating, previewing, and accessing multimedia content

(75) Inventors: Jens Jonasson, Los Angeles, CA (US); Megan O'Toole, West Hollywood, CA (US); David Krovitz, Calabasas, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/810,198

(22) Filed: Jun. 4, 2007

(51) Int. Cl. G06F 3/048

(52) U.S. Cl. 715/803

(57) ABSTRACT

An interface for navigating and previewing content is provided. In one example, an interface includes a plurality of content modules displayed in a two-dimensional array, each content module associated with a summary of content and an initial display. The initial display may include, for example, an image and text associated with the content. Selection of a content module causes a display of the summary of the content within the display space of the content module, and subsequent to the selection (e.g., in response to a user selecting a new content module or indicating they are done) the content module display is different than the initial display, thereby allowing a user to determine which content modules have been previously selected. The summary of the content may include a portion of the associated content, and may further include a link for accessing the associated content.

### BACKGROUND

1. Field

The present invention relates generally to systems and methods for user interfaces, and in one example, to an interactive content display and navigation interface for viewing and accessing content within a browser environment.

2. Related Art

The Internet and other networks interconnect computers and computing devices to allow for easy transport of data over network connections. Commonly, computers and computing devices are organized using well-known client-server models, wherein network connections are established between some computers or computing devices that act as servers and some computers or computing devices that act as clients. An example of a server is a web server and an example of a client is a web client such as a personal computer device running a web browser program. Generally, a web client operates according to the interface to issue requests to web servers, using well-known (or other suitable) protocols. In response to requests received, web servers return data responses. In a typical web client-server interaction, HTTP protocol is used, wherein the web client issues a request directed at a particular web server address for a page represented by a URL in the request and a server responsive to the particular web server address responds with data that may be a page to be displayed or other data set. Generally, regardless of the actual data being requested and returned, the data returned is referred to as a web page.

Web browsers are known and are in common use and often provide functionality in addition to presenting web pages and accepting user input related to presented web pages. For example, web pages may provide an organization of links to additional information or content, and may include program elements that are executed by a web browser upon receipt of a web page including such program elements. One example of such program elements includes JAVA® applets.

Various manners in which to display and navigate content via web pages are known. For example, headings or thumbnails may be displayed within a browser window and selectable by a user to access, e.g., link to, additional information in a new page or window. As the amount of content desirably included or linked within a single web page increases it generally becomes increasingly difficult to provide a useful and appealing display for navigating and accessing such content.

### BRIEF SUMMARY

According to some aspects of the inventions provided herein, systems and methods for navigating, previewing, and accessing content on a device (e.g., a computer, personal computer, mobile computer device, and the like) are provided.

In one example described herein, an interface for previewing and accessing content includes a plurality of content modules displayed in a two-dimensional array, each content module associated with a summary of content and an initial display. The initial display may include, for example, an image and/or text associated with the content. Selection of a content module causes a display of the summary of the content within the display space of the content module. The summary of the content may include a portion of the associated content (e.g., the first 500 characters of an article, low-resolution photo, etc.), and may further include a link for accessing the associated content (e.g., more content than the summary or the full content). Selection of the link may launch a new window, display space, or application separate from the content module space. Subsequent to the selection of a content module (e.g., in response to a user selecting a new content module or indicating they are done) the content module display is different than the initial display, thereby allowing a user to determine which content modules have been previously selected.

In one example, each content module includes an associated set of displays, e.g., an initial or default display for displaying prior to a selection thereof, a summary display for displaying in response to the selection, and a done display for displaying after the summary display has been displayed, wherein the initial display and the done display are different. In one example, each content module initially displays an image and text associated with the content, and displays an altered version of the image after the summary has been displayed. In other examples, an object (e.g., a check mark or the like) may be displayed with the content module to indicate the content module has been viewed. Further, in one example, when the content module is selected the initial display is rotated or flipped to display the summary.

In another aspect, apparatus is provided for causing the display of an interface for navigating and accessing content. In one example the apparatus includes logic for causing the display of a plurality of content modules in a two-dimensional array, each content module associated with a summary of content and displaying an initial display. The apparatus further includes logic for causing the display of the summary of the content within the content module in response to a selection of the content module and displaying a done display after the summary is displayed, the done display different than the initial display. The summary of the content may include a portion of the associated content, and may further include a link for accessing the associated content.

In another aspect of the present invention, a method is provided for navigating and accessing content. In one example, the method includes displaying a plurality of content modules, wherein each content module is associated with a summary of content and displays an initial display, displaying a summary of additional content associated with a content module in response to a selection thereof, the summary displayed within the content module, and displaying a done display within the content module different than the initial display after the summary has been displayed. The summary of the content may include a portion of the associated content, and may further include a link for accessing the associated content.

According to another aspect of the present invention, a computer-readable medium encoded with computer program instructions for navigating and accessing content is provided. In one example, the computer program instructions include program code for causing the display of a plurality of content modules, wherein each content module is associated with a summary of the additional content and an initial display, program code for causing the display of a summary of additional content associated with a content module in response to a selection thereof, the summary displayed within the content module, and program code for causing the display of a display different than the initial display after the summary has been displayed. The summary of the content may include a portion of the associated content, and may further include a link for accessing the associated content.

The various aspects and examples of the present inventions are better understood upon consideration of the detailed description below in conjunction with the accompanying drawings and claims.

### BRIEF DESCRIPTION OF THE DRAWINGS

FIG. 1 illustrates an exemplary environment in which some aspects and examples described herein are used;

FIGS. 2A and 2B illustrate exemplary interactive interfaces for viewing and navigating content;

FIGS. 3A-3D illustrate exemplary display states and operation of the display of a content module in response to user actions;

FIG. 4 illustrates an exemplary content module transition in response to user input;

FIG. 5 illustrates an exemplary method for displaying content modules and content associated therewith;

FIGS. 6A-6F illustrate exemplary content module displays associated with content comprising text (e.g., articles);

FIGS. 7A-7E illustrate exemplary content module displays associated with content comprising images;

FIGS. 8A-8F illustrate exemplary content module displays associated with content comprising videos;

FIGS. 9A and 9B illustrate another exemplary interface for displaying and navigating content via a plurality of displayed content modules; and

FIG. 10 illustrates an exemplary computing system that may be employed to implement processing functionality for various aspects of the invention.

### DETAILED DESCRIPTION

The following description is presented to enable a person of ordinary skill in the art to make and use the inventions. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the inventions. Thus, the present inventions are not intended to be limited to the examples described herein and shown, but are to be accorded the scope consistent with the claims.

In one aspect and example described herein, an interface (or an interface element) is provided for navigating and accessing content. In one example, the user interface displays a plurality of content modules, where each of the displayed content modules is associated with a summary (e.g., a preview or portion of additional content, which may depend on the content type) of additional content such as text, images, audio, videos, services, applications, and the like. The summary further includes a link to access or direct a user to the content itself. In one example, the content module initially displays an image, icon, text, or other indicia related to the content associated therewith. In response to selection of the content module, the summary associated therewith is displayed, which may include text, images, audio/video files, etc., thereby allowing a user to preview the content without leaving a current page (or opening a new page) to decide if worth accessing in full. The user may then select the link to access more content (e.g., the full content). Additionally, the content module may alter its display after being viewed to indicate to a user that the content has been accessed or viewed.

In one example, the modules are displayed in a grid or array of a window and may be scaled automatically to fit a user's screen or in response to user interaction. For example, a user may add content modules by adding rows or columns to the interface. The exemplary interface may increase user engagement, satisfaction, and time spent navigating and viewing content. For example, the combination of the predictable page layout enabled by the grid of content modules and the “done” display state of the content modules may create an almost game-like incentive for users to at least preview all modules in order to “complete them all”. It also makes for easy identification of new content upon revisits to the site, and users will be compelled to “complete” this content as well by previewing it or consuming it in full. Further, content modules may relate to or include advertising content.

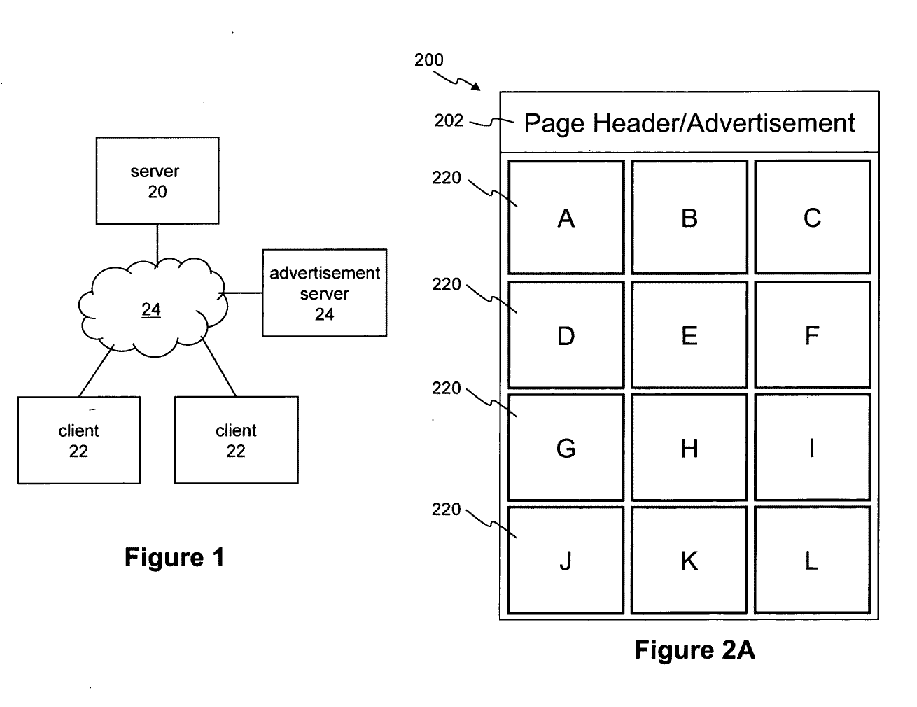

Initially, and with reference to FIG. 1, an exemplary environment in which certain aspects and examples of the user interface and methods described may operate. Generally, one or more clients 22 may access a server 20. The server 20 and clients 22 may include any one of various types of computer devices, having, e.g., a processing unit, a memory (which may include logic or software for carrying out some or all of the functions described herein), and a communication interface, as well as other conventional computer components (e.g., input device, such as a keyboard/keypad and/or mouse, output device, such as display). For example, client 22 may include a desktop computer, laptop computer, mobile device such as a mobile phone, web-enabled phone, smart phone, television, television set-top box, and the like.

Clients 22 and server 20 may communicate, e.g., via suitable communication interfaces via a network 24, such as the Internet. Clients 22 and server 20 may communicate, in part or in whole, via wireless or hardwired communications, such as Ethernet, IEEE 802.11b wireless, or the like. Additionally, communication between clients 22 and server 20 may include various servers such as a mail server, mobile server, media server, and the like.

Server 20 generally includes logic (e.g., http web server logic) or is programmed to format data, accessed from local or remote databases or other sources of data and content, for presentation to users of clients 22, preferably in the format discussed. For example, server 20 may format data and/or access a local or remote database to communicate an interface to clients 22, content modules for display within the interface (which may include multiple display states as indicated below), summary and/or preview of associated content, links to additional content, or the additional content.

To this end, server 20 may utilize various web data interface techniques such as Common Gateway Interface (CGI) protocol and associated applications (or “scripts”), Java® “servlets”, i.e., Java® applications running on a web server, or the like to present information and receive input from clients 22. The server 20, although described herein in the singular, may actually comprise plural computers, devices, databases, associated backends, and the like, communicating (wired and/or wireless) and cooperating to perform some or all of the functions described herein. Server 20 may further include or communicate with account servers (e.g., email servers), mobile servers, photo servers, video servers, and the like. For example, a content module may be associated with additional content accessible via a server remote to the server associated with the displayed interface.

Further, displayed content modules, summary/previews of content, and the associated content accessible or displayed to client 22 may include various text and media objects such as articles, documents, photos, audio files, video files, and the like. Additionally, the content may include selections or links to further content accessible by the interface and associated user device, e.g., via Application Programming Interfaces (APIs), web pages, and the like stored or accessed locally or remotely. Content accessible by client 22 via a presented web page (within the content modules or accessible via the content modules) may conform to any suitable data format including various media formats such, e.g., still image (e.g., JPEG, TIFF), video (e.g., MPEG, AVI), or audio (e.g., MP3, OGG).

Additionally, FIG. 1 illustrates an advertisement server 24, which may communicate with server 20, one or more client 22, or combinations thereof. In one example, advertisement server 24 operates to associate advertisements with user-generated actions (e.g., selections of content modules/content). Server 20 may transmit or cause the display of the advertisement data with a displayed interface or web page to client 22, in one example, within a header or footer of the displayed page, and in another example, within a displayed content module of the interface. In other examples, advertisement server 24 may send the advertisement data directly to client device 22 based on information from server 20 (e.g., based on client activity or client id/profile), client 22 (based on an identification of client 22), or the like.

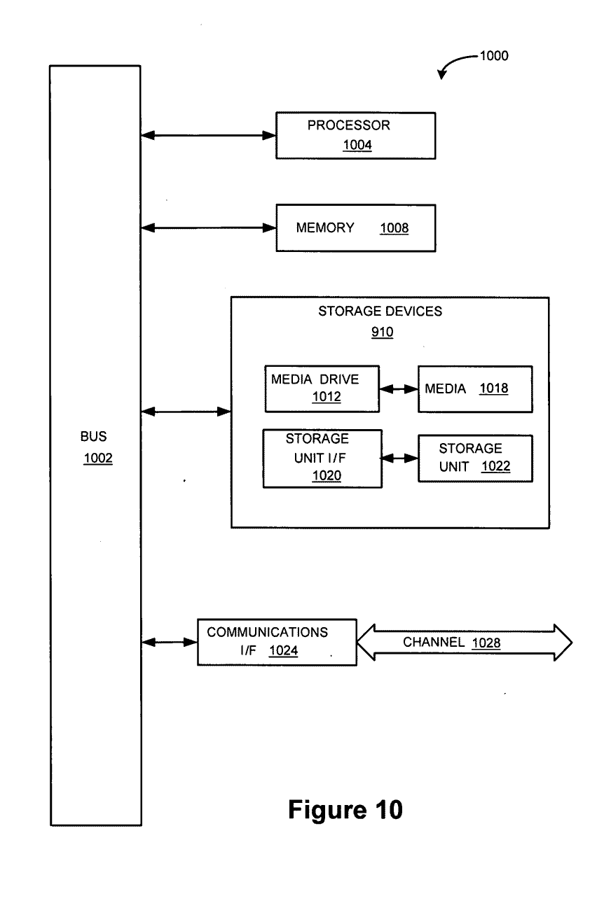

It should be noted that although the exemplary methods and systems described herein describe use of a separate server and database for performing various functions, other embodiments could be implemented by storing the software or programming that operates to cause the described functions on a single device or any combination of multiple devices as a matter of design choice so long as the functionality described herein is performed. Although not depicted in the figures, server 20 generally includes such art recognized components as are ordinarily found in server systems, including but not limited to processors, RAM, ROM, clocks, hardware drivers, associated storage, and the like (see, e.g., FIG. 10, discussed below). Further, the described functions and logic may be included in software, hardware, firmware, or combination thereof.

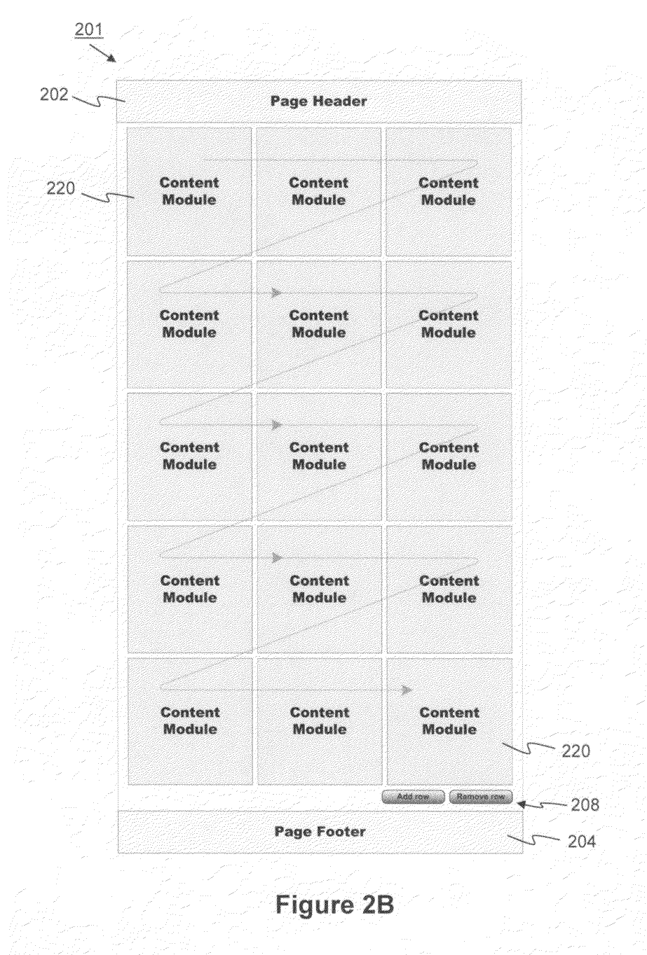

FIGS. 2A and 2B illustrate exemplary user interfaces 200 and 201 for displaying and navigating content via a plurality of displayed content modules 220, each associated with content and a summary of the content. With reference initially to FIG. 2A, interface 200 includes a plurality of content modules 220 displayed in a 3 by 4 grid or array of content modules, where each content module 220 is associated with additional content. In one particular example, each content module 220 is selectable by a user to access a summary or preview of additional content that is displayed within the content module 220; for example, upon clicking a content module 220, a summary of the additional content is displayed within content module 220 (e.g., within the space of the selected content module 220). Additionally, the summary or preview may further provide access or a link to the additional content, which may open or launch a new window or application to access the additional content.

In one example, each content module 220 is displayed having the same dimensions (in this example, displayed as squares, but other shapes such as rectangular, circular, oval, irregular shapes, etc., are possible). Content modules 220 may be automatically configured and sized based on a display of a user device, e.g., based on resolution and/or size of a display. For example, for a user having a wide-screen monitor (e.g., a 1440 by 900 resolution monitor relative to a 1024 by 768 resolution monitor) additional columns of content modules may be displayed. Additionally, in some examples, a user may select to reduce or increase the number of rows or columns of the array (see, e.g., controls 208 of interface 201 shown in FIG. 2B for adding or removing columns).

The uniform nature of the array of content modules 220, i.e., where each content module 220 is the same or similar size within interface 200, may make it easier for a user to predict (or quickly preview) what is available in a lower portion of interface 200, which may be positioned in an area of a web page not visible in a user's browser window when the page is initially loaded. As such, a user may be more likely to scroll down the page to discover more content (and complete, e.g., preview, all of the content modules). This may free a service provider from a traditional constraint of presenting as much content as possible “above the fold” (i.e., in the area of the web page that is visible in the user's browser window when the page is first loaded into the browser). This constraint typically leads to either a reduced quantity of content that can be presented or a dull or crowded presentation (e.g. largely a list of text headlines).

As described, content modules 220 may be associated with different types of content such as articles, photos, videos, audio, advertising, polls, combinations thereof, and any other content suitably displayed or accessed via a webpage. The initial display of content modules 220 and the summary of content associated therewith may vary for each type of content. The order of content modules may be laid out in the grid per the order determined by an operator of the server. In one example, the content modules are displayed in chronological order starting with the most recent content in the upper left corner, where as a new content module is display the remaining content modules shift to the right (wrapping to the row if at the end position of a row) as illustrated by the arrow in FIG. 2B.

In one example, individual content modules 220 are selected by positioning a pointer (e.g., an arrow, hand, or other graphic associated with a user device) over the desired content module 220 and selecting, e.g., by clicking a mouse. It will be recognized that other methods, e.g., via keystrokes or other suitable input devices, may be used to highlight or select one of the displayed content modules 220. A user may therefore engage and select different displayed content modules 220 to view previews and content associated therewith.

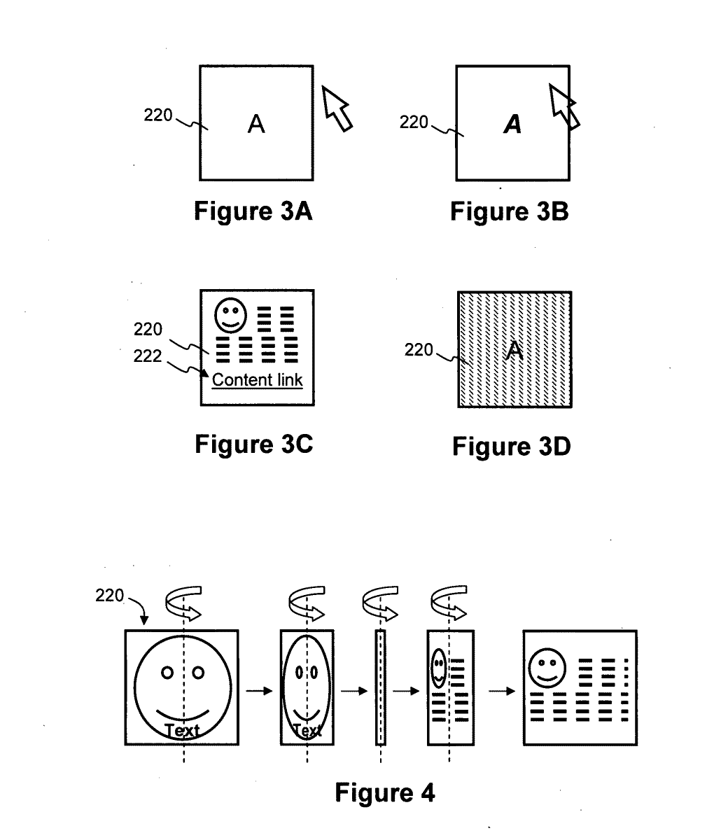

In one example, each content module 220 has multiple display states associated therewith, which may vary in response to user actions, as illustrated in FIGS. 3A-3D. For example, a first display state of the content module (e.g., FIG. 3A) includes an initial or default state, which is displayed initially prior to a user previewing or hovering over the content module. The first display state may comprise a title and/or image to provide an indication of the associated content to a user.

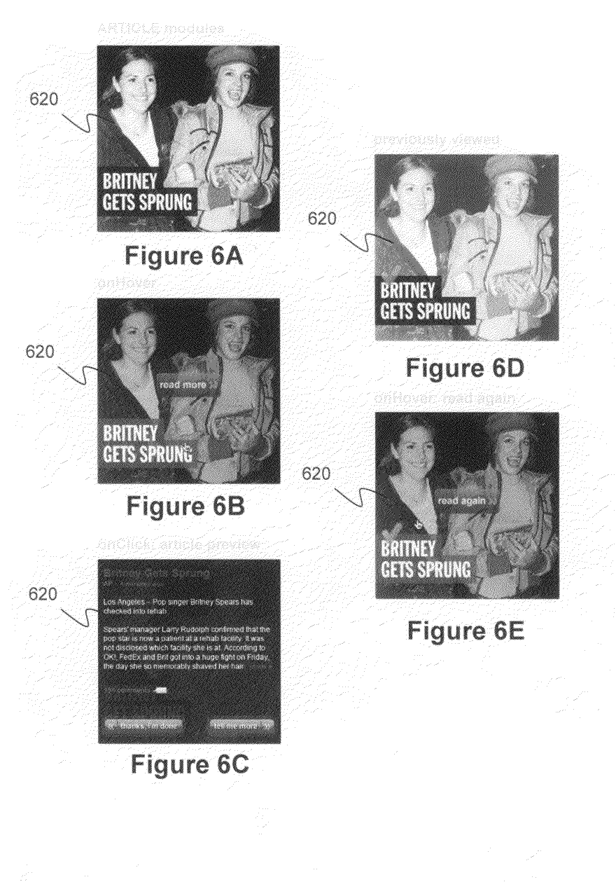

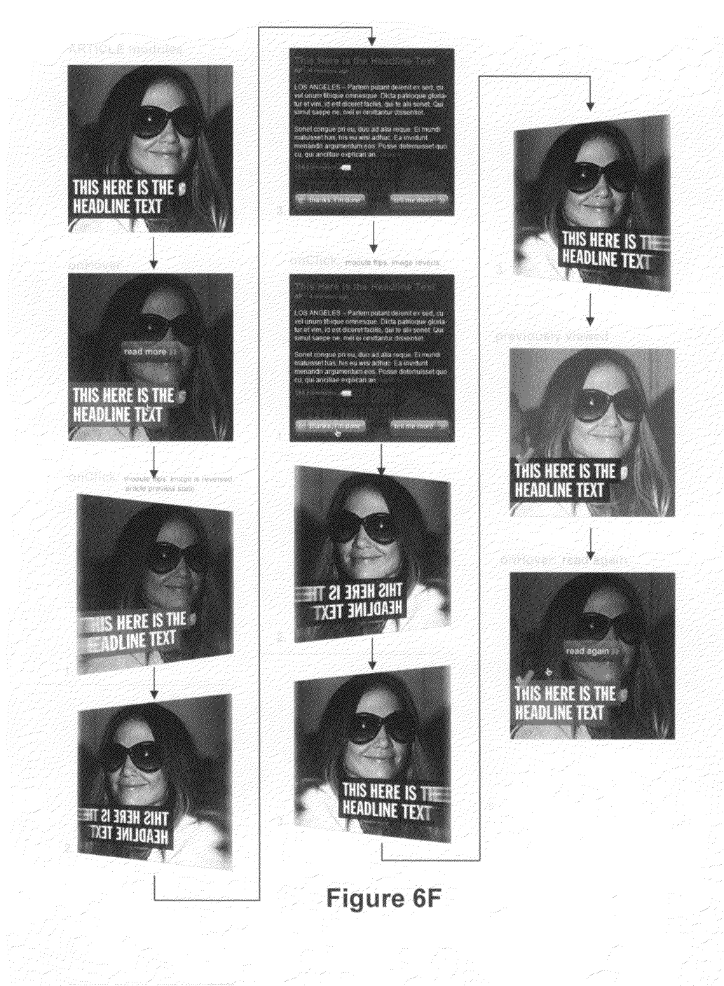

A second display state may include a hover display state (e.g., FIG. 3B), wherein when a user is “hovering” over a content module 220 (e.g., wherein a pointer is positioned over a display content module 220, but a selection has not been made), the display of content module 220 is altered in appearance. For example, a change in the image or text, or additional images or text may be displayed. In one example, the image may become shaded or opaque during a hover and text presented (e.g., as illustrated in FIGS. 6B, 7B, and 8B described below). Further, in one example, the content module may become animated, e.g., moving portions, changing colors, or other non-static effects in response to a hover (which may include the animation described below with respect to FIG. 4).

A third display state (e.g., FIG. 3C) may comprise displaying a summary or preview of the content or a portion of the content itself. For example, a summary of an article might include the title and first 500 characters; a summary of a photo may include a thumbnail version; a summary of a video may include a low-resolution and/or clip from a full length, full-resolution video clip; and so on. The displayed summary may further include a button or link (which may include a hyperlink to content local o remote to the server associated with page 200 or 201) to access additional content associated therewith (e.g., the full content).

A fourth display state (e.g., FIG. 3D) may comprise a display, different than the first display state, indicating to a user that the particular content module has been previously selected or viewed. For example, the image or text of the first display state may be altered, e.g., shaded or colored, checked or X'd-out, or otherwise displayed in a different fashion to be distinguishable from other display content modules that have not been accessed. Additionally, the display may further vary to indicate whether a user accessed only the preview/summary or accessed the additional content associated therewith. Exemplary images for various states of content modules are illustrated in greater detail in FIGS. 6A-6F, 7A-7E, 8A-8D. Displaying previously accessed content modules in such a fashion provides a quick visual way to determine which content has been previewed and/or accessed.

Further, it will be recognized that a server system may store and cause the display of the described content modules and display states in a variety of fashions using well known methods and systems. For example, a server system and/or associated database may store or access necessary data and files for causing the display of each of the described display states for each content module. A set of display states for each content module may be communicated to a user as part of the initial webpage or information for additional display states communicated in response to user input. Further, the server may store or access the content for generating the summaries as well as desired applications/scripts (which could be downloaded to the client) for causing transition effects, if included. In some examples, a cookie may be stored with the client for storing data to indicate which content modules have been viewed, and the like, for affecting the display of the content modules (additionally such data may be kept in session).

It will be recognized that additional display states may be used and some display states described may be omitted; for example, an interface can merely include the default display state and preview/summary display state (e.g., FIGS. 3A and 3C). Accordingly, an interface may vary the number of display states depending, e.g., on user preferences/selections, device capabilities, and the like.

Further, the transition from one display state to the next, e.g., from the display of the second display state to the third display state or from the third display state to the fourth display state, may include various effects, and in one example, may be animated. For instance, in one example, the displayed first state of a content module 220 rotating or flipping to display the next state (e.g., to appear as a tile or coin being flipped over to display the summary on the backside thereof) as illustrated schematically in FIG. 4. For example, the displayed content module 220 rotates, appearing to a user to rotate or flip about the axis shown, and displays the summary of the associated content on the reverse side thereof. Various other transition effects are possible for moving from one display stage to the next; for example, fading, visual effects such as flashes or explosions, sound effects, combinations thereof, and so on.

Additionally, interfaces 200 or 201 may include a display region 202 for displaying a page header and/or advertisement information. The selection of an advertisement within display region 202 may be based on various factors, including, but not limited to, user profile information, user history information (e.g., search or viewing history of a user), the display of content modules 220 within interface 200, selection of particular content modules 220, combinations thereof, and the like. Further, it should be understood that the display region 202, including the header or an advertisement may change over time, e.g., at regular time intervals, in response to user inputs and manipulation of interface 200, and so on. Similarly, a page footer 204 may be displayed as illustrated in FIG. 2B, and include page information and/or advertisement information. In yet other examples, one or more content modules 220 may include an advertisement with or without the functionality of the other display content modules described (e.g., preview, hover, and/or done).

In one example, interface 200 or 201, whether as a stand alone interface or an element of a larger interface or web browser page, may be accessible by a user via an online account such as an email account. For example, a user may login to an account server, and interface 200 or 201 may be included in a “home” page or otherwise displayed in response to a user login. As such, interface 200 may be customizable, e.g., in terms of the appearance of the array of content modules, the display states, the level of content accessible in via the default and preview display states, content, and so on. Further, interface 200 or 201 may include or be part of one or more widgets. In these and other fashions, an individual user may access interface 200 or 201 from multiple client devices; for example, interface 200 or 201 may be served from a computer server to a user accessing the server from various devices such as a personal computer, work computer, mobile computer device such as a phone, and the like. In other examples, of course, interface 200 or 201 may be included as an application program running on a computer device.

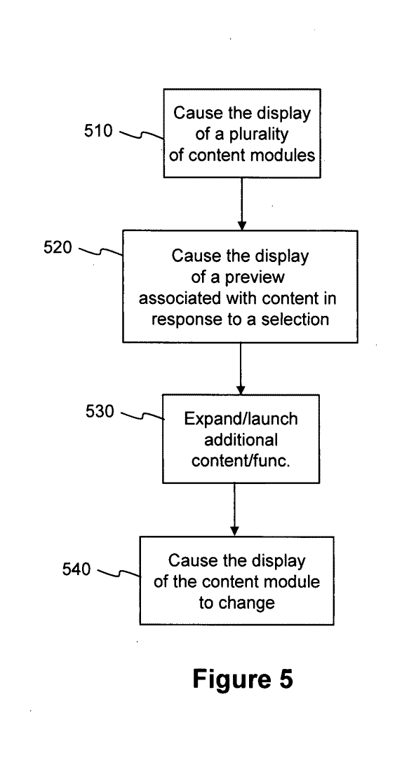

FIG. 5 illustrates an exemplary computer implemented method for causing the display of content modules and content associated therewith. For example, the method may be carried out by a server device (e.g., a web server) via a presented web page to a client device. Initially, the method includes causing the display of a plurality of content modules at 510 within an interface, e.g., within a web page. The content modules may be displayed in a two-dimensional array of content modules as described herein, and may be included within a served web page that may contain other features such as a page header, advertisement information, and the like. Further, the arrangement of content modules may be controlled by the server or client device.

The method further includes causing the display of content at 520 (e.g., a preview or summary of additional content or a portion of the associated content) in response to a user selection of a content module. In one example, the content is displayed within the content module, e.g., within the display space of the selected content module. The transition from the originally displayed content module to the display of the content may take various forms including animating the content module to rotate or flip over to appear to contain the content on the backside of the content module.

The content displayed at 520 further includes a button or link operable to direct the user to additional content. The method further includes causing a new window or application to be opened in response to a user selection of the button or link within a content module at 530. For example, selecting a link to a news story may open a new window containing the additional content. Additionally, a selection may cause the client device to launch an application program such as a media player to display an audio or video file. In other examples, the browser page may link to the content within the window of the display of the plurality of content modules (wherein the user may return to the display of the plurality of content modules via a “back” function, for example).

The method further includes causing the display of a selected content module to be altered at 540 after the content module has been selected (either at 520 and/or the user as accessed additional content via the content module at 530). As described, the content module may vary in various manners to indicate to a user that the content module has been previous selected and/or the content accessed.

FIGS. 6A-6E illustrate exemplary displays of a content module 620 associated with content, in this example, the content comprising an article. FIG. 6A illustrates a first display state, e.g., an initial or default state, prior to selection by a user. FIG. 6B illustrates content module 620 in a second display state, wherein a user is hovering over content module 620 (e.g., the pointer “hand” is over content module 620). In this display state, the image has been shaded and the text “read more” has been overlaid on the image. In some examples, additional text associated with the content could be displayed in this state. Further, the image may include animation or other moving effects in this state.

FIG. 6C illustrates content module 620 in a third display state after being selected by a user. As seen, content module 620 displays a preview or summary of additional content that is accessible via a link or control button included therein, e.g., “more”. In response to a user selection the content module can display additional content, e.g., a longer preview, or link to additional content. Additionally, a user may select they are done, in which case content module 620 may be displayed as illustrated in FIG. 6D.

As illustrated in FIG. 6D, in this example, the content module image may be altered (e.g., made opaque, shaded, etc.). Additionally, an indicium, e.g., a check mark, may be displayed to indicate to a user that the particular content module has been previously viewed. Additionally, an animated or moving feature may be added to the content module, e.g., the check mark or other indicium can move. Additionally, as illustrated in FIG. 6E, upon hover of a previously selected content module, the content module display may be changed, similarly to an unselected content module, and text “read again” included.

FIG. 6F further illustrates varying display states of an exemplary content module in sequential order according to one example. Additionally, in this example, the initial image and text become reversed as the initial content module display “flips” from the initial state to the preview state. Further, when the user indicates they are done with the preview state, the content module “flips” back from the reversed image to the restored initial image (but varied according to the previously viewed state, in this example, made opaque and displaying a check mark). It will be recognized that in an actual implementation of this example, the motion of the content module may appear smooth as it flips from one display state to another.

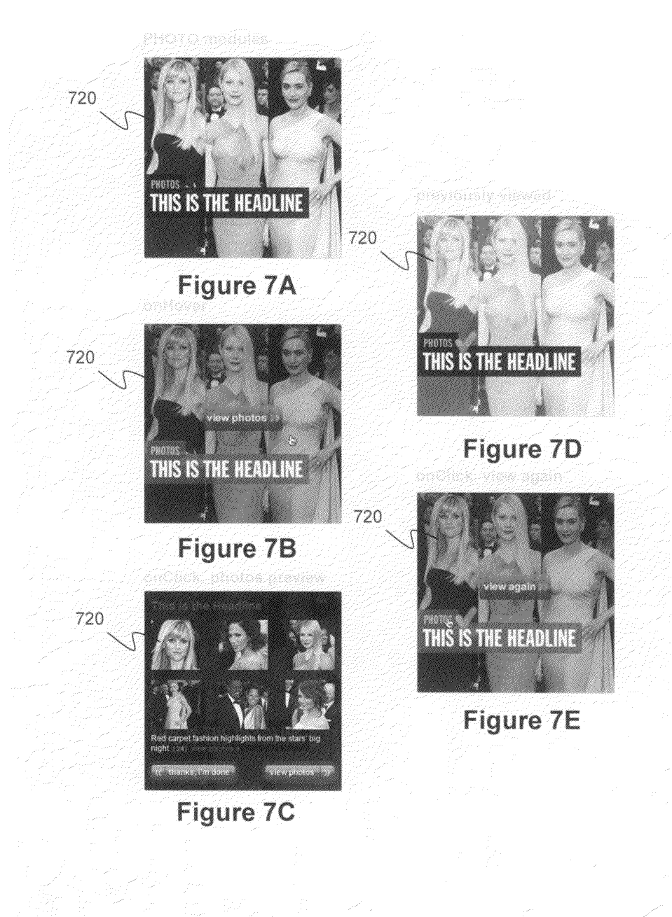

FIGS. 7A-7E illustrate exemplary displays (e.g., display states) of a content module 720 associated with content comprising images. FIGS. 7A-7E are displayed similarly to those of FIGS. 6A-6E, however, the display of content module 720 and navigation may be tailored for viewing photos. For example, content module 720 illustrated in FIG. 7C may display one or more thumbnails associated with higher resolution photos accessible by clicking on the photo itself or selecting “view photos,” which may launch a new window or application for viewing the photos.

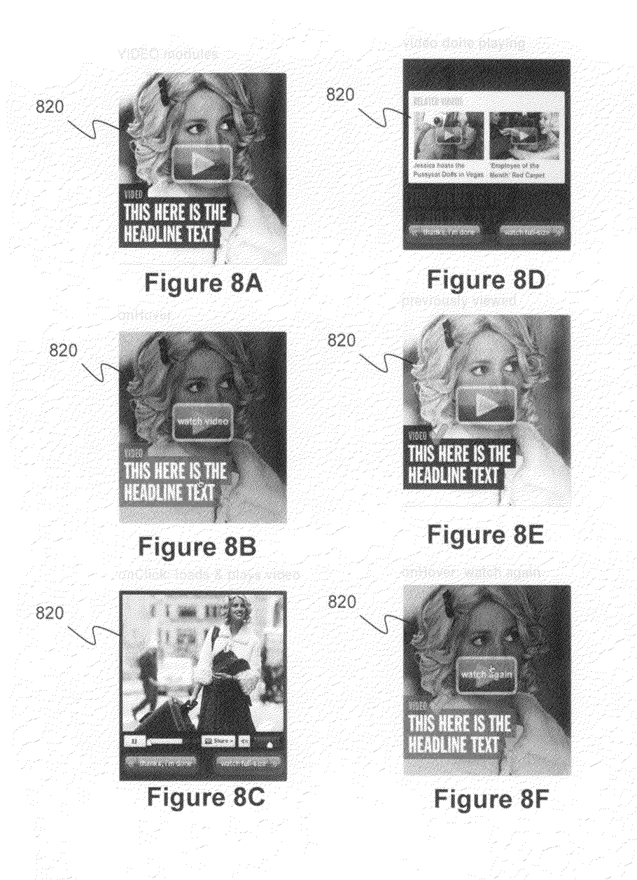

FIGS. 8A-8F illustrate exemplary displays (e.g., display states) of a content module 820 associated with content comprising videos. FIGS. 8A-8E are displayed similarly to those of FIGS. 6A-6E, however, the display of content module 820 and navigation may be tailored for viewing videos. For example, content module 820 illustrated in FIG. 8C may display a short video clip associated with additional content, e.g., a longer or higher resolution video file. Further, content module 820 illustrated in FIG. 8D may be displayed after a preview clip has been viewed for accessing other content, e.g., related video files, or to access additional content, e.g., “watch full-size,” to access the full length and/or higher resolution video file.

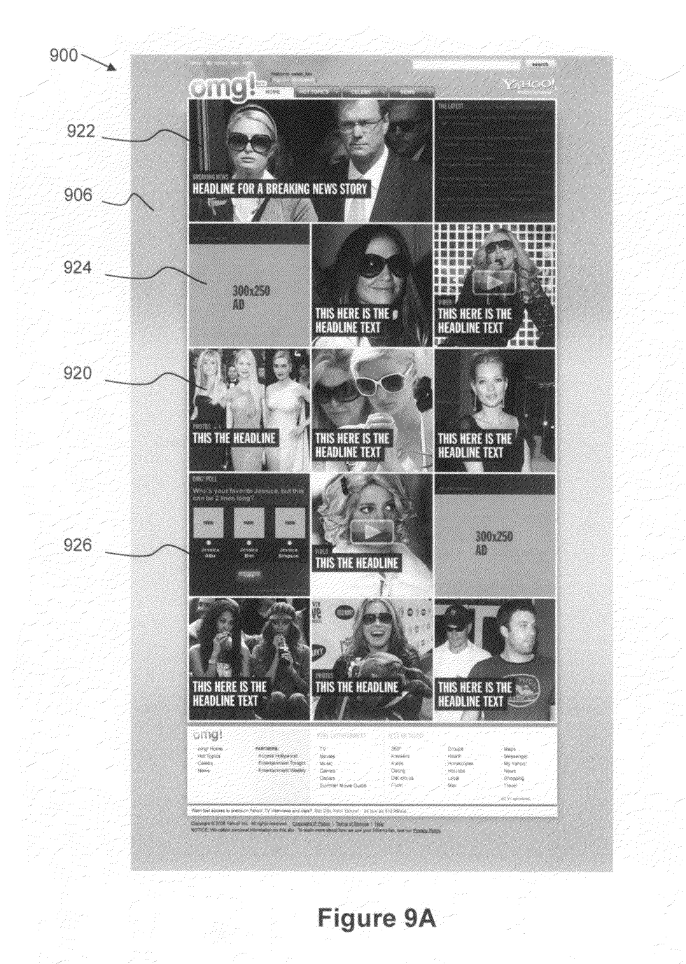

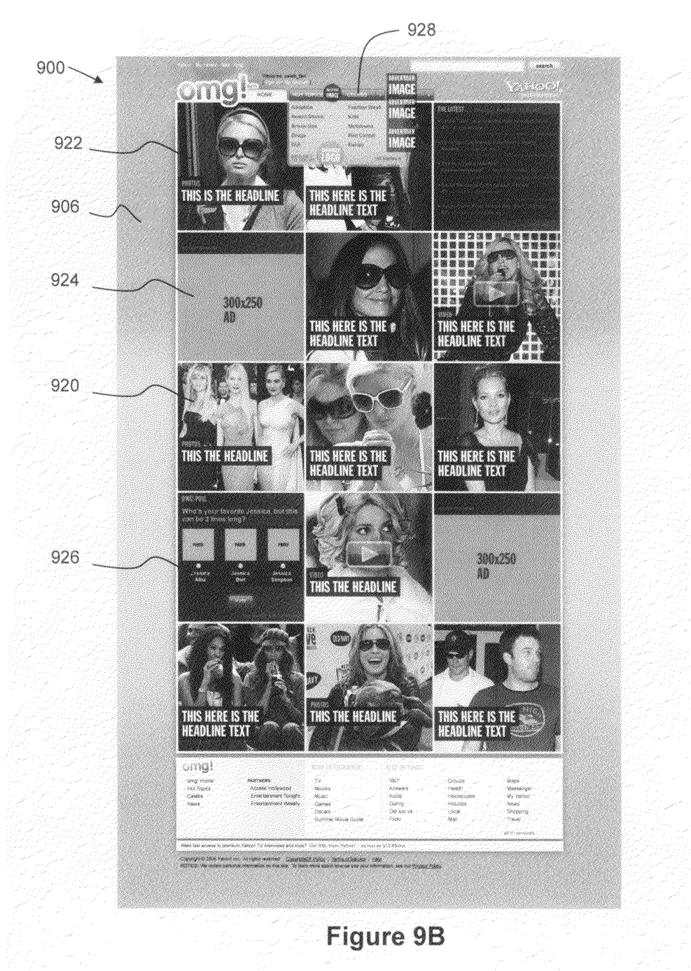

FIGS. 9A and 9B illustrate another exemplary interface 900 for displaying and navigating content via a plurality of displayed content modules. Additionally, in this example, interface 900 includes a content module 922 that is larger than some of the other content modules 920 (specifically, in this example, content module 922 is the size of two content modules 920, but other varying sizes are possible). In one example, a larger content module may be reserved for the latest content, e.g., breaking news or the like. Content module 922 may operate in response to user actions similarly to that described with respect to content module 220 above.

Further, interface 900 may include at least one content module 924 for an advertisement as illustrated. Such a content module 924 may or may not be interactive similar to the described content modules herein. Additionally or alternatively, the background portion of interface 900 (or a window in which interface 900 is displayed) may include advertisement information, such as a company or product logo displayed in the background. In yet another example, at least one content module 926 supports a user poll, which may include a sponsored poll.

In another example, as indicated in FIG. 9B, interface 900 may further include one or more drop down menus 928 for navigating additional content or displaying a new interface of content modules. For example, drop-down menus 928 may lead to similar user interface displays according to another category, such as hot topics, sports, news, business, or the like. Further, interaction with the drop-down menu may additionally cause the display of one more advertisements within or associated with the drop-down menu.

FIG. 10 illustrates an exemplary computing system 1000 that may be employed to implement processing functionality for various aspects of the invention (e.g., as a server device or system, a client device, mobile device, memory device, and so on). Those skilled in the relevant art will also recognize how to implement the invention using other computer systems or architectures. Computing system 1000 may represent, for example, a desktop, mainframe, server, memory device, mobile client device, or any other type of special or general purpose computing device as may be desirable or appropriate for a given application or environment. Computing system 1000 can include one or more processors, such as a processor 1004. Processor 1004 can be implemented using a general or special purpose processing engine such as, for example, a microprocessor, microcontroller or other control logic. In this example, processor 1004 is connected to a bus 1002 or other communication medium.

Computing system 1000 can also include a main memory 1008, for example random access memory (RAM) or other dynamic memory, for storing information and instructions to be executed by processor 1004. Main memory 1008 also may be used for storing temporary variables or other intermediate information during execution of instructions to be executed by processor 1004. Computing system 1000 may likewise include a read only memory (“ROM”) or other static storage device coupled to bus 1002 for storing static information and instructions for processor 1004.

The computing system 1000 may also include information storage mechanism 1010, which may include, for example, a media drive 1012 and a removable storage interface 1020. The media drive 1012 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1018 may include, for example, a hard disk, floppy disk, magnetic tape, optical disk, CD or DVD, or other fixed or removable medium that is read by and written to by media drive 1014. As these examples illustrate, the storage media 1018 may include a computer-readable storage medium having stored therein particular computer software or data.

In alternative embodiments, information storage mechanism 1010 may include other similar instrumentalities for allowing computer programs or other instructions or data to be loaded into computing system 1000. Such instrumentalities may include, for example, a removable storage unit 1022 and an interface 1020, such as a program cartridge and cartridge interface, a removable memory (for example, a flash memory or other removable memory module) and memory slot, and other removable storage units 1022 and interfaces 1020 that allow software and data to be transferred from the removable storage unit 1018 to computing system 1000.

Computing system 1000 can also include a communications interface 1024. Communications interface 1024 can be used to allow software and data to be transferred between computing system 1000 and external devices. Examples of communications interface 1024 can include a modem, a network interface (such as an Ethernet or other NIC card), a communications port (such as for example, a USB port), a PCMCIA slot and card, etc. Software and data transferred via communications interface 1024 are in the form of signals which can be electronic, electromagnetic, optical, or other signals capable of being received by communications interface 1024. These signals are provided to communications interface 1024 via a channel 1028. This channel 1028 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 1008, storage device 1018, or storage unit 1022. These and other forms of computer-readable media may be involved in providing one or more sequences of one or more instructions to processor 1004 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into computing system 1000 using, for example, removable storage drive 1014, drive 1012 or communications interface 1024. The control logic (in this example, software instructions or computer program code), when executed by the processor 1004, causes the processor 1004 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

1. An interface for previewing and accessing content, the interface comprising:
a plurality of content modules displayed in a two-dimensional array, each content module associated with a summary of content and an initial display, wherein:
the content module displays the summary of the content within the content module in response to a selection of the content module, and
subsequent to displaying the summary, the content module display is different than the initial display.

2. The interface of claim 1, wherein the summary comprises a portion of the associated content.

3. The interface of claim 1, wherein the summary is generated automatically from the associated content.

4. The interface of claim 1, wherein the summary comprises a link to the content.

5. (canceled)

6. The interface of claim 1, wherein each content module comprises the initial display for displaying prior to a selection thereof, a summary display for displaying in response to the selection, and a done display for displaying after the summary display has been displayed, wherein the initial display and the done display are different.

7. (canceled)

8. The interface of claim 1, wherein selection of a content module further causes the initial display of the content module to rotate to display the summary.

9. The interface of claim 1, wherein subsequent to a selection of the content module an image included with the initial display of the content module is displayed in an altered state.

10. The interface of claim 1, wherein subsequent to a selection of the content module an object is displayed with the content module, the object indicating the content module was previously selected.

11-12. (canceled)

13. Apparatus for causing the display of a content navigation interface, the apparatus comprising:
logic for causing the display of a plurality of content modules in a two-dimensional array, each content module associated with a summary of content and an initial display;
logic for causing display of the summary of the content within the content module in response to a selection of the content module; and
logic for causing display of a done display for displaying after the summary of the content is displayed, the done display different than the initial display.

14. The apparatus of claim 13, wherein the summary comprises a portion of the associated content.

15. The apparatus of claim 13, wherein the summary is generated automatically from the content.

16. (canceled)

17. The apparatus of claim 13, wherein the content is accessible in a window or display space separate from the content module.

18. The apparatus of claim 13, further comprising logic for causing a display of an initial display for displaying prior to a selection thereof, a summary display for displaying in response to the selection, and a done display for displaying after the summary display has been displayed, wherein the initial display state and the done display state are different.

19. The apparatus of claim 13, wherein each content module initially displays an image and text associated with the content.

20. A method for previewing and accessing content via a user interface, the method comprising the acts of:
displaying a plurality of content modules, wherein each content module is associated with a summary of content and an initial display;
displaying a summary of additional content associated with a content module in response to a selection thereof, the summary displayed within the content module; and
displaying a done display within the content module different than the initial display after the summary has been displayed.

21. The method of claim 20, wherein the summary comprises a portion of the associated content.

22. The method of claim 20, wherein the summary is generated automatically from the content.

23. (canceled)

24. The method of claim 20, wherein the content is accessible in a window or display space separate from the content module.

25. The method of claim 20, further comprising displaying an initial display of the content module prior to a selection thereof, a summary display in response to the selection, and a done display after the summary display has been displayed, wherein the initial display state and the done display state are different.

26. A computer-readable medium encoded with computer program instructions for previewing content is provided, the computer program instructions comprising:
program code for causing the display of a plurality of content modules, wherein each content module is associated with a summary of the additional content and an initial display;
program code for causing the display of a summary of additional content associated with a content module in response to a selection thereof, the summary displayed within the content module; and
program code for causing the display of a display different than the initial display after the summary has been displayed.

27. The computer program product of claim 26, wherein the summary comprises a portion of the associated content.

28. The computer program product of claim 26, wherein the summary is generated automatically from the content.

29. The computer program product of claim 26, wherein the summary comprises a link to the content.

30. The computer program product of claim 26, wherein the content is accessible in a window or display space separate from the content module.

31. The computer program product of claim 26, further comprising program code for an initial display of the content module prior to a selection thereof, a summary display in response to the selection, and a done display after the summary display has been displayed, wherein the initial display state and the done display state are different.
